(19) United States
(12) Patent Application Publication
(10) Pub. No.: US 2002/0165755 A1
(43) Pub. Date: Nov. 7, 2002

(54) Method of predicting behavior of a customer at a future date and a data processing system readable medium

(76) Inventor: Brendan J. Kitts, Cambridge, MA (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 09/681,397

(22) Filed: Mar. 29, 2001

(51) Int. Cl. G06F 17/60

(52) U.S. Cl. 705/10

(57) ABSTRACT

A computer-implemented method can be used to predict the behavior of a customer of a vendor at a future date. The method can comprise accessing data regarding the vendor's customers and generating timeseries information for at least one of the vendor's customers. The method can also comprise training a model to obtain weights. The training can be performed using at least some of timeseries information. The method can further comprise predicting the behavior of the first customer at the future date. The prediction can be performed using the weights in the model and at a frequency greater than monthly. A data processing system readable medium may include code having instructions to carry out the method

### BACKGROUND OF INVENTION

1. Field of the Invention

This invention relates in general to methods of predicting behavior and data processing system readable media, and more particularly, to methods of predicting behavior of a customer and data processing system readable media having code for carrying out those methods.

2. Description of the Related Art

Customer retention and revenue are very important concepts to retailers. Retailers need to know which customers are about to defect, so that they can take action, send special offers and discounts, to prevent them from going to a competitor. Revenue forecasting is also important, so that retailers can design promotions targeted to the most important customers in the population.

Previous approaches to solve this problem have been deficient in several ways: (1)Previous systems have required manual effort to generate or renew forecasts. Manual intervention is often needed when the data changes, when new forecasts are desired, or when results need to be displayed aggregated in a different manner.

(2) Automated approaches to-date have generated backward-looking accounting results (eg. top visitors, top spenders), rather than forward-looking forecasts relating to spending and visitation in the next period.

(3) Automated forward-looking forecasts, if supplied at all, are highly simplistic. Typically the customer's future spending is assumed equal to their past spending, multiplied by a discount factor. The combination of elaborate timeseries behavioral analysis, with automated forecasting is not available in prior art.

Some companies maintain a group of statisticians or direct marketers who periodically develop custom predictive models to predict future customer spending or churn. These systems require considerable manual intervention to develop forecasts on new data.

Prior automated systems have steered away from the difficult task of customer-behavior forecasting, and instead use approaches based on historical RFM metrics. RFM stands for Recency, Frequency, Monetary. RFM measures each customer in terms of their last visit date, visit frequency, and revenue spending. Other transactional data can also be measured.

The problem with RFM is that it only provides a picture of the customer's past visitation and spending, and does not reveal their future behavior.

### SUMMARY OF INVENTION

A computer-implemented method and data processing system readable medium can be used to make more timely predictions of customer behavior. In one embodiment, transactional data of a customer can be added to timeseries information regarding the customer at the time of the transaction or shortly therafter.

A computer-implemented method can be used to predict the behavior of a customer of a vendor at a future date. The method can comprise accessing data regarding the vendor's customers and generating timeseries information for at least one of the vendor's customers. The method can also comprise training a model to obtain weights. The training can be performed using at least some of timeseries information. The method can further comprise predicting the behavior of the first customer at the future date. The prediction can be performed using the weights in the model and at a frequency greater than monthly.

In some embodiments, the generation of the timeseries information can be performed daily or substantially in real time. The behavior may include customer retention or revenue and may be predicted using only revenue-based variables.

In other embodiments, outlier detection and removal can be performed. A first-level outlier limit may be used to remove customer data exceeding the limit before training. A second-level outlier limit can be used to remove data before making a prediction. The second-level outlier limit may be for the same type of data but have a value less than the first-level outlier limit. In one specific example, the second-level outlier may be used to remove customer data exceeding the limit after training.

The method can be used with a model having an approximator that may include polynomial regression, a decision tree, a spline, or the like. In one specific example, the model may only use revenue-based variables for each customer and polynomial regression.

In other embodiments, a data processing system readable medium can have code embodied within it. The code can include instructions executable by a data processing system. The instructions may be configured to cause the data processing system to perform the methods described herein.

The foregoing general description and the following detailed description are exemplary and explanatory only are not restrictive of the invention, as claimed.

### BRIEF DESCRIPTION OF DRAWINGS

The present invention is illustrated by way of example and not limitation in the accompanying figures, in which like references indicate the same elements, and in which:

FIG. 1 includes an illustration of a functional block diagram of a system that can be used in performing computer-implemented methods;

FIG. 2 includes an illustration of a data processing system storage medium including software code having instructions in accordance with an embodiment of the present invention; and

FIG. 3 includes a process flow diagram illustrating a method of behavior of a specific customer at a future date.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Methods and data processing system readable media can be used to predict behavior of a customer at a future date. Data can be efficiently used to create timeseries information for a customer in a more timely basis. The timeseries information could be created daily or substantially in real time. The models can be created for any number of approximators and variables. The methods can be run at nearly any time without a requirement that the method use information from closed accounting books. Various levels of outlier protection can be used to improve the robustness of the models. The present invention is defined by the appended claims and is described with respect to embodiments below.

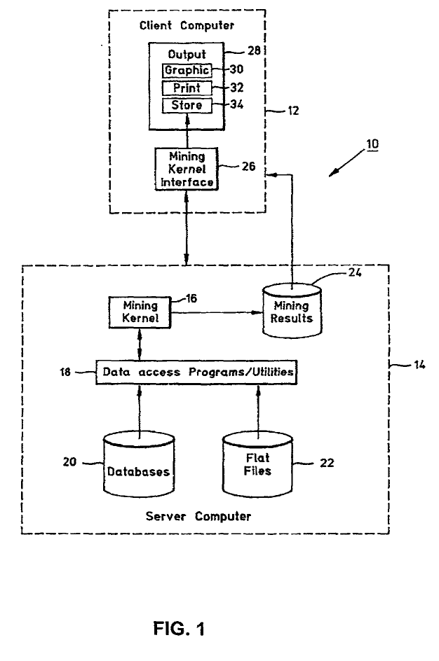

FIG. 1 includes a system 10 for mining databases. In the particular architecture shown, the system 10 can include one or more data processing systems, such as a client computer 12 and a server computer 14. The server computer 14 may be a Unix computer, or OS/2 server, or Windows NT server, or the like. The server computer 14 may own a database system, such as DB2 or ORACLE, or it may have data on files on some data processing system readable storage medium, such as disk or tape.

As shown, the server computer 14 includes a mining kernel 16 that may be executed by a processor (not shown) within the server computer 14 as a series of computer-executable instructions. These instructions may reside, for example, in the random access memory (RAM) of the server computer 14. The RAM is an example of a data processing system readable medium that may have code embodied within it. The code can include instructions executable by a data processing system (e.g., client computer 12 or server computer 14), wherein the instructions are configured to cause the data processing system to perform a method of predicting behavior of a customer. The method is described in more detail later in this specification.

FIG. 1 shows that, through appropriate data access programs and utilities 18, the mining kernel 16 can access one or more databases 20 or flat files (e.g., text files) 22 that contain data chronicling transactions. After executing the instructions for methods, which are more fully described below, the mining kernel 16 can output relevant data it discovers to a mining results repository 24, which can be accessed by the client computer 12.

Additionally, FIG. 1 shows that the client computer 12 can include a mining kernel interface 26 which, like the mining kernel 16, may be implemented in suitable software code. Among other things, the interface 26 may function as an input mechanism for establishing certain variables, such as the size of windows, the approximator to be used. Further, the client computer 12 may include an output module 28 for outputting/displaying the mining results on a graphic display 30, a print mechanism 32, or a data processing system readable storage medium 34.

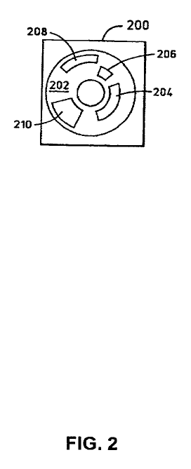

In addition to RAM, the instructions in an embodiment of the present invention may be contained on a data storage device with a different data processing system readable storage medium, such as a floppy diskette. FIG. 2 illustrates a combination of software code elements 204, 206, 208 and 210 that are embodied within a data processing system readable medium 202, on a floppy diskette 200.

Alternatively, the instructions may be stored as software code elements on a DASD array, magnetic tape, conventional hard disk drive, electronic read-only memory, optical storage device, CD ROM or other appropriate data processing system readable medium or storage device.

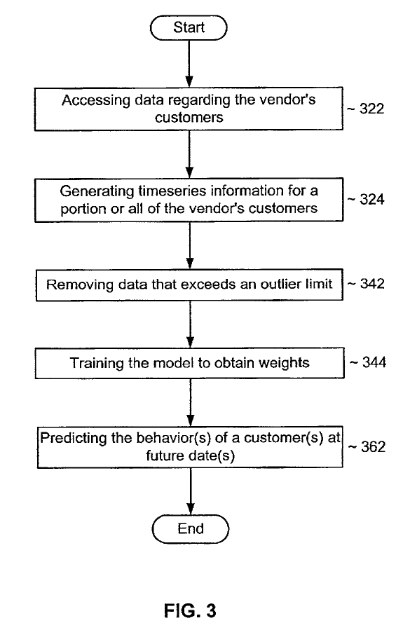

In an illustrative embodiment of the invention, the computer-executable instructions may be lines of compiled C⁺⁺, Java, or other language code. Other architectures may be used. For example, the functions of the client computer 12 may be incorporated into the server computer 14, and vice versa. FIG. 3 include illustrations, in the form of flow charts, of the structures of such software programs.

Communications between the client computer 12 and the server computer 14 can be accomplished using electronic or optical signals. When a user (human) is at the client computer 12, the client computer 12 may convert the signals to a human understandable form when sending a communication to the user and may convert input from a human to appropriate electronic or optical signals to be used by the client computer 12 or the server computer 14. Part of the communications may be achieved using an On-Line Analytical Processing (OLAP) Graphical User Interface (GUI) that may be used to show the forecasting results for each customer. The significance of the OLAP GUI is described later in this specification.

1. Collect the Data.

The method starts with collecting behavioral data regarding customers of a vendor. This data may be in the form of revenue, quantity, number of views, number of mouse-clicks, or the like. Hereinafter, revenue will be used to refer to customer behavior based on a monetary measure including money spent by a customer, profit of the vendor attributed to a customer, or the like. The behavioral data of the customer can be collected on a transactional basis but is not necessarily limited that way. For example, aggregate sales for the year by customer could be used. When data is obtained on a transactional basis, each transaction can be noted by a customer identifier, quantities of the various items purchased, and date of purchase.

The transactional data will typically be for a store (site) or chain of stores (sites) of a vendor with scores of categories. Each of the sites may represent a physical location or an Internet or other electronic site. The store or chain of stores can have at least 1,000 different items and in some instances over 10,000 different items. Items is beign used to denote products, services, or both available from a vendor. The amount of sales data can exceed one million data points. However, note that more or fewer items may be used and more or fewer data points may be collected.

If possible, a whole year's worth of data should be collected. However, due to costs, time, or other constraints, this may not be possible. If a whole year's worth of data is not collected, the user should be aware of potential seasonal changes in some products. Within a grocery store, sales of cocoa and hot chocolate may be higher in the winter. If the data is only collected during winter, the model may overestimate sales of cocoa or hot chocolate during summer. Therefore, the user should be careful to examine seasonal effects, if any, for the categories of items being monitored. General merchandisers tend to have elevated sales over the Christmas period, whereas grocery stores experience an increase of different products during Thanksgiving, and over summer/winter seasons.

The data regarding customers of the vendor can be collected and stored by the vendor within database 20 of the server computer 14. The data regarding the vendor's customers may be accessed by the client computer 12 or the server computer 14 as shown in block 322 of FIG. 3.

2. Generate Customer Profiles (Timeseries) Using a Grouping Algorithm.

The next stage is to generate customer timeseries information for a portion or all of the vendor's customers (block 324). In some instances, customer timeseries information can be generated as a customer is added or as the customer timeseries changes. Alternatively, the customer timeseries information can be generated on a periodic basis only for those customers where new information is available within database 20. The periodic basis may be hourly, daily, or at nearly any other user-defined basis. A timeseries-based profile of the customer can be in a form of a vector with all the items that the customer has purchased during a period and summarized in some manner.

A technique can be used for efficiently building the timeseries information. The method can proceed by accessing the data regarding the customers of the vendor (from database 20) and performing a contiguous re-ordering of the transaction data. The algorithm, known as a grouping algorithm, can take the transactional data and order the data by customer. The ordered data has the same data but the records for any particular customer may be found on contiguous rows. This may be accomplished by re-ordering runs in linear time. An operation being performed linearly or in linear time means that the time for performing the operation is directly proportional to the number of records within the database. In other words, the computation time is substantially directly proportional to N, where N is the product of the number of customers of the vendor and the number of items carried by the vendor or a site of the vendor.

In installations where a grouping algorithm is not available, the data can be sorted by customer. Sorting algorithms are less efficient than the grouping algorithm. The computation time is substantially directly proportional to N*log(N). However, both approaches (sorting or grouping) virtually eliminate the problem of the size of the data when working with limited size of RAM accessible to a processor. The RAM limitation and “freeing” space within RAM are discussed later.

After the data is contiguously re-ordered or sorted, customer timeseries of visits, amount (revenue, profit, quantity of items bought) can be built. In many instances, the information for amount can be broken down by item, category of items, groups of categories, or the like. The sales data used to build the customer timeseries can range over nearly any period of time, but preferably should include at least one customer purchasing cycle. For example, if the data is for a grocery store, the data should include at least seven days worth of data because many customers buy groceries on a seven-day cycle. This seven-day cycle is also observed by many retailers (not limited to grocery stores). Data for more than one purchasing cycle may be used, if available and desired. This transactional data can be obtained in any number of ways, but one of the most common is point-of-sales data.

While building a customer timeseries, a new transaction record can be read. The profile for the customer to whom that transaction belongs is initialized. The next transaction is read, and as long as the customer is the same as the previous customer, the timeseries information (profile) for that customer profile is updated. If a new customer is detected, the data processing system (e.g., computer 12 or 14) can package up the profile for the previous customer and flush the customer profile, which frees up RAM space.

During “packaging,” the profile for the previous customer is completed (all calculations, if any, are completed), and the revised information can be sent to and stored in a database 20 or file (e.g., storage medium 34) containing the final profiles, which can include customer timeseries information.

After packaging, the data processing system (computer 12 or 14) frees the RAM occupied by the last customer's data and profile before processing information related to the next customer. An advantage of the procedure is that profiles can be constructed with as little as a single pass of the transaction data, and using a relatively small amount of memory.

3. Apply Outlier Filter Banks.

After timeseries for the customers are generated, customers who appear to be clearly erroneous are removed from further consideration due to the presence of outliers. Outliers typically include unusually large purchases by an individual or group of individuals. Many times, these large purchases are from resellers rather than typical customers because the reseller may be able to get a better price during a sale from the retailer than it normally would from its regular supplier. In one specific example for a grocery store, the outlier detection may remove sales data where the amount of groceries purchased by any single customer is at least one thousand dollars ($1000). Most families typically do not buy this level of groceries from one store in a week and it is believed that sales higher than that number would represent resellers. Outlier thresholds are determined by statistical analysis performed in a training phase, where the spending of customers outside a set number of standard deviations (e.g., 10 or 20) is set as the threshold. The method removes data that exceeds the first-level outlier limit (block 342).

The filter banks can be based on transactions (visits) higher than normal, revenue higher than normal, quantity higher than normal, customers with no data for the current period, or the like. Customers with no history may have no data from which to predict behavior. Therefore, forecasting for these customers should be handled differently. Thus, the focus can be on customers who have been observed at least once in the window being used. The concept of window is explained in more detail later in this specification.

4. Group Timeseries and Statistics.

After all individual customer data has been calculated and data for outlier customers removed from further consideration, the data for a single site-wide or vendor-wide group or groups of customers (divisions determined by a user) can be calculated. Within the group(s), data from calculations may include visits during the time period, average amounts spent per item, category, group of categories, or the entire store by the average customer within the group, and standard deviations for any or all those average amounts.

5. Build Behavioral Models Using Variables.

A. Variables.

After outlier-filtered customers are collected, the mining kernel 16 via the mining kernel interface 26 can try to find any patterns in the behavior of customers. Finding these patterns may be made easier by building a range of variables that might be predictive of retention/defection or revenue consistency or changes in the future. Some of the specific variables can include revenue-based variables, visits-based variables, seasonal/monthly indicators, geographic information, etc.

Revenue can be represented on a daily basis (revseries, weekly, monthly, or over an even larger period (sumseries for all past data). A resseries is a resolution series that represents an average per time period (e.g., average weekly revenue). The aggregate weekly revenue appears to work well for predicting revenue and retention.

Visits can be represented on a daily basis, time since last visit, average time between visits, or as a percentage of visits during a time period over normal visit period (time since last spike divided by the average time between spikes, expressed as a fraction).

For customer visits, the analysis can be based on a digital representation. Either the customer purchased something or the customer did not; the customer purchased something over a predetermined value or the customer did not, the customer visited the store or the customer did not. Each of these measures may be used to determine customer retention. Therefore, in this specific embodiment, all the daily sales data can be converted to a series of 1s and 0s to correspond to visits.

In other embodiments, the threshold for determining a visit could be changed.

For example, the retailer may not be concerned about an individual that just stopped by the store to buy one item at less than one dollar ($1), and therefore may set a minimum daily spending limit.

Seasonal/monthly indicators can show that revenue for some items vary by seasons or months. Within a grocery store, accuracy in predicting customer behavior may improve by approximately three to four percent when seasonal/monthly indicators are used.

Geographic information can include distance to vendor's nearest store, distance to competitor's nearest store, or both. The revenue and retention should be inversely proportional to the distances or squares of the distances. The data is better correlated in rural areas compared to urban areas.

A user can select nearly any variable or combination of variables to examine how it affects the models. To simplify the model, the variable(s) having relatively insignificant affects may be eliminated.

B. Approximators for the Models.

Five different approximators may be used. Polynomial regression takes all available variables and attempts to find a set of weights that transform the inputs to a value as close possible to the target values (during training). In one example, an equation may be the following.

rₜ₊₁=wₜrₜ+wₜ₋₁rₜ₋₁+wₜ₋₂rₜ₋₂ . . . w₀r₀ where, r are the weekly aggregated sales data for a customer; and w are weights corresponding the weekly aggregated sales data that are obtained from auto-regression.

Other variable(s) can be used in place of or conjunction with the weekly aggregated sales data.

Another approximator includes a decision tree. Variable values may be split into groups. With enough splits, the tree eventually isolates customers with different target values. Splines are another example of an approximator that is related to the distance an individual customer's variable value is from one or more clusters of group-wide average variable values.

Nearest neighbor may be used to assign a value from a group to an individual customer. Logistic regression can be used for binning values of variables.

Of the approximators, the polynomial regression appears to be the best approximator, nearest neighbor appears to be the worst approximator, and logistic regression does not to work very consistent.

6. Window selection and trainingDatabase 20 may have 400 days of historical data. However, the RAM of client computer 12 or server computer 14 may only have access to no more than 100 days of purchases at a time. As a result, a user may need to carefully window the large historical timeseries to create training data which uses training windows to predict the following same or lesser number of days.

Variables that can be used to define the windowing method include the size of the training window, delay, size of the prediction window, prediction aggregation, and skip interval(s). Each of these can be expressed in units of time, such as days. The size of the training window can be pre-set as part of the software code or can be set by a user. Typically, the size training window (days of data) should include at least one business cycle's worth of data, be at least the same size as the prediction window, or both.

Regarding delays, forecasting sometimes is not for the next day. Sometimes, retailers are more interested in knowing what may occur in two weeks from now.

This is often the case because retailers need time to act, and for instance, cannot take action in less than two weeks (items may need to be ordered from the vendor's supplier). Thus, the delay can be a period after the training window.

The size of the prediction window can include the number of days that are being predicted. Prediction aggregation can be used to determine if total sales, average sales, average revenue, etc. are being predicted within the prediction window.

Skip interval can be used to reduce a problem seen with using every possible training-window, prediction-window case. Customers with a large number of transactions may have their patterns dominate the cases being observed (since more cases involving them are created). To reduce effects of some customers from dominating, the training window may skip every two, three, or more days.

In general, the number of observed behavioral patterns is equal to:

$$\frac{Total\_time series - Training\_window - Delay - Prediction \_window )}{Skip\_interval}$$

For example, up to 330 observations are possible for a 400 day historical timeseries with a 30 day training window, a 10 day delay, a 30 day prediction window, and a skip interval of one day. After the windows have been set, the method can be used to train the model to obtain the weights (block 344). The weights can be determined using at least some of the timeseries information previously described. If a polynomial regression is being used, the weights (wₜ, wₜ₋₁, wₜ₋₂, . . . , w₀) can be used in the training window to predict values for the predictive window using historical data.

7. Predictions into the Future.

Using the weights from training, the method can be used to predict the behavior(s) of customer(s) at future date(s) as shown in block 362 of FIG. 3. The behavior can be revenue, visits, pages viewed, mouseclicks, or the like. The variable being predicted and the variables used to make the prediction may be the same or different. Revenue-based variables can be used to prediction customer revenue or retention in the future. Date(s) refers not only to specific date(s) but could refer to time period(s) in the future (e.g., a week, a month, or the like).

The OLAP GUI can be used to show the forecasting results for each customer. The GUI can allow a business user to then identify customers who are forecasted to defect during the next period and target them for a campaign designed to win back their loyalty.

The system described includes an automated and scalable system for forecasting the future revenue and retention behavior for millions of customers. The system can present those results in a convenient graphical user interface (e.g., the OLAP GUI) for analysis and campaign planning. No prior art exists, to our knowledge, which performs customer-forecasting on millions of customers, in an automated way without the need for continual human intervention.

Embodiments described herein are useful for obtaining information more timely. The recording of the transactional data and customer timeseries information can be performed in real time or nearly real time. In real time, after transactional data for a customer is entered into database 20, computer 12 or 14 can be used to update the customer timeseries information. If the computer 12 or 14 does not currently have capacity to update the customer timeseries information, the computer 12 or 14 may perform the update as soon as it has the capacity, in which case the customer timeseries information is processes and recorded in near real time. Alternatively, the customer timeseries information may be processed when computer activity is relatively lower (e.g., overnight or weekend).

After the user chooses window sizes for training and prediction, the any of the models can be run relatively frequently. For example, the models can be run more often than monthly. Many retailers may want to run the models bimonthly or weekly because many retailers have business cycles that are bimonthly or weekly. The more frequent running allows a business to identify more quickly customers that are predicted in the future to spend significantly less revenue at the vendor's store(s) or are more likely to leave. Campaigns or promotions can be targeted at those customers identified as being most likely to have significantly reduced revenue or retention. The likelihood of retaining customers and keeping them at current spending levels can be increased because action can be taken sooner.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A computer-implemented method of predicting a behavior of a first customer of a vendor at a future date comprising:
accessing data regarding the vendor's customers;
generating timeseries information for at least one of the vendor's customers;
training a model to obtain weights, wherein training is performed using at least some of timeseries information; and
predicting the behavior of the first customer at the future date, wherein predicting is performed using the weights in the model and at a frequency greater than monthly.

2. The method of claim 1, wherein each of accessing and generating are performed at least daily.

3. The method of claim 1, wherein each of the accessing and generating are performed substantially in real time.

4. The method of claim 1, wherein the behavior includes likelihood of retention.

5. The method of claim 1, wherein the behavior includes future revenue.

6. The method of claim 1, wherein:
accessing is performed for a second customer; and
the method further comprises removing a datum for the second customer before training because the datum for the second customer exceeds an outlier limit.

7. The method of claim 6, wherein removing the datum for the second customer is performed after training.

8. The method of claim 1, wherein the model uses an approximator selected from a group consisting of a polynomial regression, a decision tree, and a spline.

9. A data processing system readable medium having code embodied therein, the code including instructions executable by a data processing system, wherein the instructions are configured to cause the data processing system to perform a method of predicting a behavior of a first customer of a vendor at a future date, the method comprising:
accessing data regarding the vendor's customers;
generating timeseries information for at least one of the vendor's customers;
training a model to obtain weights, wherein training is performed using at least some of timeseries information; and
predicting the behavior of the first customer at the future date, wherein predicting is performed using the weights in the model and at a frequency greater than monthly.

10. The data processing system readable medium of claim 9, wherein each of accessing and generating are performed at least daily.

11. The data processing system readable medium of claim 9, wherein each of the accessing and generating are performed substantially in real time.

12. The data processing system readable medium of claim 9, wherein the behavior includes likelihood of retention.

13. The data processing system readable medium of claim 9, wherein the behavior includes future revenue.

14. The data processing system readable medium of claim 9, wherein:
accessing is performed for a second customer; and
the method further comprises removing a datum for the second customer before training because the datum for the second customer exceeds an outlier limit.

15. The data processing system readable medium of claim 14, wherein removing the datum for the second customer is performed after training.

16. The data processing system readable medium of claim 9, wherein the model uses an approximator selected from a group consisting of a polynomial regression, a decision tree, and a spline.
